(19) United States
(12) Patent Application Publication
(10) Pub. No.: US 2006/0107597 A1
(43) Pub. Date: May 25, 2006

(54) Refrigerator, door opening apparatus and door opening process thereof

(75) Inventors: Sun-mi Jin, Seoul (KR); Yong-pil Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/240,571

(22) Filed: Oct. 3, 2005

(30) Foreign Application Priority Data
Oct. 29, 2004 (KR) 2004-0087250

(51) Int. Cl. E05D 15/48

(52) U.S. Cl. 49/149

(57) ABSTRACT

A refrigerator includes a main body having a storage compartment formed therein; a door formed with a handle on a first side thereof and rotatably disposed on the main body; a sensor disposed on the door and sensing whether or not a user is touching the sensor; and a rotational cam mechanism having a plurality of rotational cam units, each of the rotational cam units having a different rotational radius, installed in the main body and opening the door sequentially according to a sensing of the sensor.

### CROSS-REFERENCE TO RELATED APPLICATIONS

This application claims priority from Korean Patent Application No. 2004-0087250, filed on Oct. 29, 2004, in the Korean Intellectual Property Office, the disclosure of which is incorporated herein by reference.

### BACKGROUND OF THE INVENTION

1. Field of the Invention

The present invention relates to a refrigerator and, more particularly, to a refrigerator having an improved structure for opening its door.

2. Description of the Related Art

As shown in FIG. 1, a conventional refrigerator comprises a main body 2; a door 4 provided with a handle 3 on a first side thereof and rotatably disposed on a front surface of the main body 2; a door gasket 6 disposed on an inner peripheral part of the door 4 and sealing a space between the main body 2 and the door 4. With this configuration, when the handle 3 is pulled away, the door 2 is opened by separating the door gasket 6 from the main body 2, and when the handle 3 of the door 2 is pushed back, the door 2 is closed.

A user only depends on physical force to open the door 2 of the refrigerator having the above structure, so that at least a certain amount of force is required to open the door 2 of a large sized refrigerator. Consequently, for a user who relatively lacks physical strength like an elderly person, a child, etc., it can be a burden to open the door 2.

Especially, in summer, when a temperature difference between the inside and outside of the refrigerator is large, more physical force is required to open the door 2.

To solve this problem, Japan Patent First Publication No. 2002-257466 discloses a refrigerator opening its door automatically due to a rotational force of a cam.

However, a large sized refrigerator carries a big electrical load when it has the above door opening structure because it employs only one cam. Thus, the door opens abruptly rather than gently, thereby lowering utility of the door and generating noise. Also, an operating structure of the cam is complicated.

### SUMMARY OF THE INVENTION

Accordingly, it is an aspect of the present invention to provide a refrigerator having a door formed so as to open gently.

The foregoing and/or other aspects of the present invention are also achieved by providing a refrigerator comprising a refrigerator comprising a main body having a storage compartment formed therein; a door formed with a handle on a first side thereof and rotatably disposed on the main body; a sensor disposed on the door and which senses whether or not a user is touching the sensor; and a rotational cam mechanism comprising a plurality of rotational cam units, each of the rotational cam units having a different rotational radius, installed in the main body and opening the door sequentially according to a sensing of the sensor.

According to an exemplary embodiment of the present invention, the rotational cam units are rotatable at the same time according to a sensing of the sensor.

According to an exemplary embodiment of the present invention, the plurality of rotational cam units comprises a first rotational cam unit and a second rotational cam unit rotating and pushing the door to be opened, and wherein the second rotational cam unit has a larger rotational radius than that of the first rotational cam unit to open the door with a large angle.

According to an exemplary embodiment of the present invention, the first rotational cam unit is spaced further from a rotational axis of the door than the second rotational cam unit is.

According to an exemplary embodiment of the present invention, the first and second rotational cam units comprise first and second drive motors driven according to a sensing of the sensor, respectively; and first and second rotational cams rotating due to the driving of the first and second drive motors and pushing the door, respectively.

According to an exemplary embodiment of the present invention, the second rotational cam is disposed above the first rotational cam.

According to an exemplary embodiment of the present invention, the first and second drive motors stop after the first and second rotational cams rotate once, respectively.

According to an exemplary embodiment of the present invention, the refrigerator further comprises a switch which is disposed in the main body, and senses a position of at least one of the first and second rotational cams to stop the first and second drive motors.

According to an exemplary embodiment of the present invention, the switch may comprise a micro switch operative to contact with the first rotational cam unit. The switch may also comprise a hall sensor, and the first rotational cam unit is provided with a magnetic member which operates at a predetermined distance from the hall sensor.

According to an exemplary embodiment of the present invention, the refrigerator further comprises a buffer part disposed on an inner surface of the door and which the plurality of rotational cam units contact.

The foregoing and/or other aspects of the present invention are also achieved by providing a refrigerator comprising a door opening apparatus of a refrigerator which comprises a main body having a storage compartment; and a door rotatably disposed on the main body and having a handle on a first side thereof. The door opening apparatus comprises a sensor which is disposed on the door to sense whether or not a user touches the sensor; and a plurality of rotational cam mechanisms disposed on the main body, each having a different rotational radius, to open the door stepwise according to a sensing of the sensor.

According to an exemplary embodiment of the present invention, the plurality of rotational cam units comprises first and second rotational cam units rotating and pushing the door to be opened, and wherein the second rotational cam unit has a larger rotational radius than that of the first rotational cam unit to open the door with a large angle.

According to an exemplary embodiment of the present invention, the first and second rotational cam units comprise first and second drive motors driven according to a sensing of the sensor, respectively; and first and second rotational cams rotating due to the driving of the first and second drive motors and pushing the door, respectively.

According to an exemplary embodiment of the present invention, the first and second drive motors stop after the first and second rotational cams rotate once, respectively.

According to an exemplary embodiment of the present invention, the first and second drive motors are disposed at positions adjacent to the first and second rotational cams, and are stopped by a switch sensing the position of the first and second rotational cams.

According to an exemplary embodiment of the present invention, the sensor is installed on the handle.

The foregoing and/or other aspects of the present invention are also achieved by providing a refrigerator comprising a door opening method of a refrigerator, comprising sensing a user's touch through a sensor disposed on a door of the refrigerator; rotating a plurality of rotational cam units, each having a different rotational radius, according to a user's touch to contact them with the door at the same time; and opening the door with a larger opening angle of the door through one of the rotational cam units, which has a larger rotational radius.

According to an exemplary embodiment of the present invention, the plurality of rotational cam units comprises a first rotational cam unit and a second rotational cam unit for pushing the door to be opened by a rotational movement, further comprising separating the first rotational cam unit further from a rotational axis of the door than the second rotational cam unit.

According to an exemplary embodiment of the present invention, the door opening method further comprises contacting a switch with the door to sense a rotation of at least one of the plurality of rotational cam units on the main body of the refrigerator.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings, in which:

FIG. 1 is a top view illustrating a door opening structure of a conventional refrigerator,

FIG. 2 is a perspective view of a refrigerator consistent with the present invention,

FIG. 3 is a partial perspective view illustrating a door opening part installed in a refrigerator consistent with the present invention,

FIGS. 4A and 4B are views showing a state in which a door opening part, installed in a refrigerator consistent with the present invention, operates.

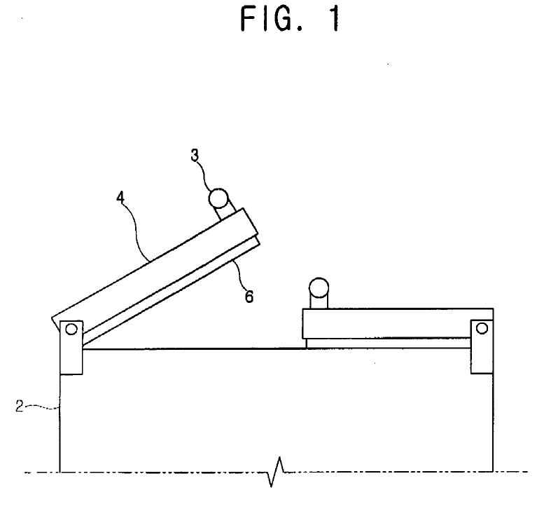

### DETAILED DESCRIPTION OF THE ILLUSTRATIVE, NON-LIMITING

### EMBODIMENTS OF THE INVENTION

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

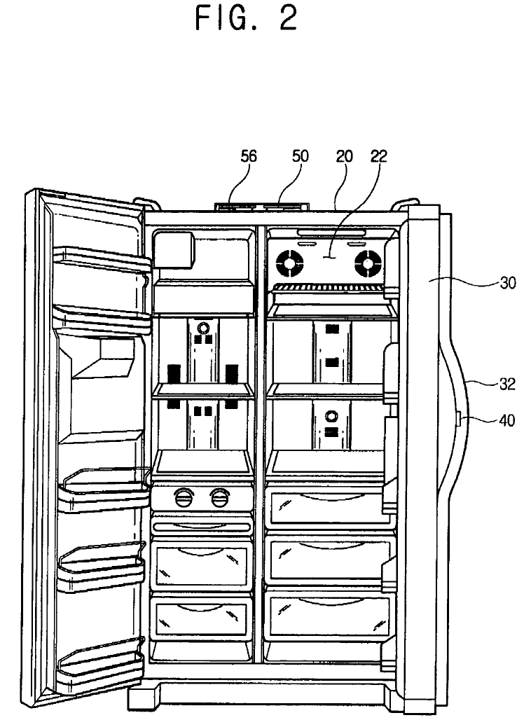

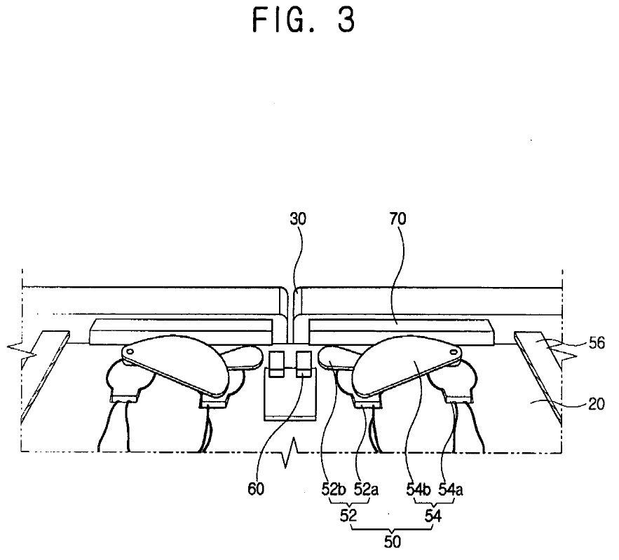

As shown in FIG. 2 and FIG. 3, a refrigerator according to the present invention comprises a main body 20 having a storage compartment 22 formed therein; at least one door 30 formed with a handle 32 on a first side thereof and rotatably disposed on the main body 20; a sensor 40 disposed on the handle 32 of the door 30 and sensing whether or not a user is touching the handle 32; and a rotational cam mechanism 50 including a plurality of rotational cam units 52 and 54, each having a different rotational radius, installed in the main body 20 and operative to open the door 30 stepwise according to a sensing of the sensor 40.

A separate rotational cam mechanism 50 may be mounted on an upper part of the main body 20 with respect to each door 30, and have a structure for opening the corresponding door 30 by pushing an inner upper part of the door 30. The rotational cam mechanisms 50 can be mounted at variable positions as occasion demands. For the sake of brevity, the following description relates to one rotational cam mechanism 50 for the door 30. Another rotational cam mechanism (unnumbered) is shown in FIG. 3 for the door (unnumbered) shown on the left side and the operation is the same.

Each of the rotational cam mechanisms 50 comprises a first rotational cam unit 52 rotating according to a sensing of the sensor 40 and pushing the door 30 to be opened; and a second rotational cam unit 54 rotating according to a sensing of the sensor 40 and pushing the door 30 to be open.

The first and second rotational cam units 52 and 54 rotate at the same time according to a sensing of the sensor 40 to minimize an electrical load required for opening the door 30. Also, the second rotational cam unit 54 has a larger rotational radius than that of the first rotational cam unit 52 to open the door 30 with a large angle. The first rotational cam unit 52 is further spaced from a rotational axis direction of a hinge part (not shown) rotating the door 30, than the second rotational cam unit 54 is.

The main body 20 is provided with a protection cover 56 to protect the first rotational cam unit 52 and the second rotational cam unit 54 from the outside.

The first and second rotational cam units 52 and 54 comprise: first and second drive motors 52a and 54a, driven according to a sensing of the sensor 40, respectively; and first and second rotational cams 52b and 54b, rotating by driving of the first and second drive motors 52a and 54a and pushing the door 30, respectively. Preferably, but not necessarily, the second rotational cam 54b be disposed above the first rotational cam 52b.

The first and second drive motors 52a and 54a automatically stop after the first and second rotational cams 52b and 54b make one rotation, respectively. A controller (not shown) controls an operation of the first and second drive motors 52a and 54a.

As shown in FIG. 3, a switch 60 is installed in a position adjacent to the first and second rotational cams 52b and 54b, thereby controlling a rotational motion of the first and second rotational cams 52b and 54b. The switch senses the moment when at least one of the first and second rotational cams 52b and 54b return to their original positions, and cuts off the first and second drive motors 52a and 54a from sources of electricity, thereby stopping the first and second rotational cams 52b and 54b at their original positions after one rotation. The first and second rotational cams 52b and 54b return to their original positions after opening the door 30, and complete the one rotation.

The switch 60 may employ any of various well known switches, such as a micro switch which operates by contact, a non-contact point switch which is provided with a hall sensor and a magnetic member, etc.

As occasion demands, the first and second drive motors 52a and 54a are able to control the first and second rotational cams 52b and 54b to return to their original positions with a reverse rotation after rotating a certain angle. A buffer part 70 is provided on an inner surface of the door 30, with which the first and second rotational cams 52b and 54b touch, to reduce an impact.

The number of the rotational cam mechanisms 50 can be varied as needed, but is shown in FIG. 3 as one rotational cam mechanism 50 per door 30. Also, a structure of the rotational cam mechanism 50 can be modified variably within a range that the rotational cam mechanism 50 opens the door 30 by pushing due to a rotational force.

It is preferable that the sensor 40 be installed in an inner side of the handle 32 of the door 30 to avoid an exposure to the outside. An installation position of the sensor 40 can be changed variably. Any well-known sensor which senses whether or not a user touches the sensor can be employed as a sensor 40. Also, the sensor 40 can employ any of various well known operation structures, such as a structure operated by a user's touch only, a structure operated by applying a certain force after a touch, etc.

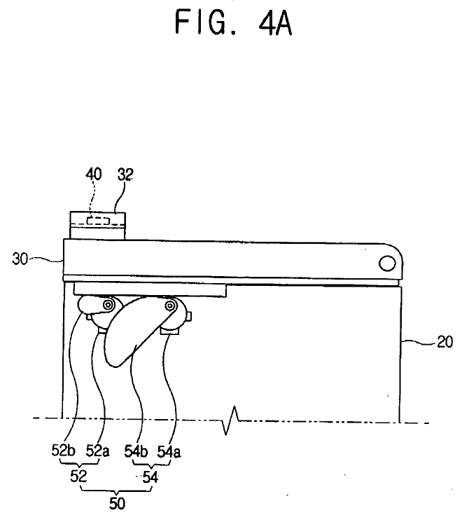

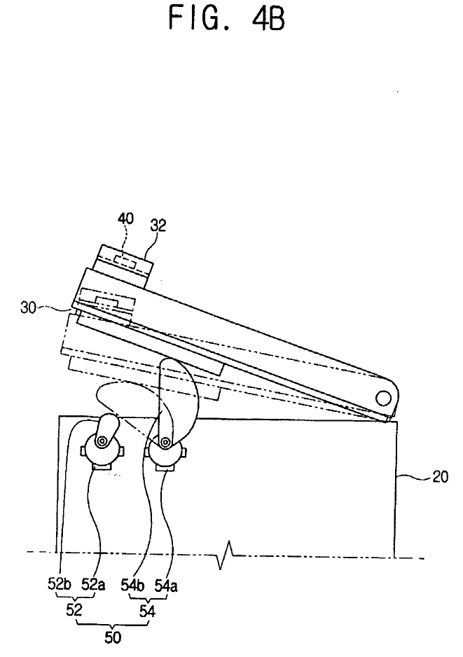

With reference to FIGS. 4A and 4B, an operation process of the rotational cam mechanism 50 of the refrigerator, described above, is as follows.

A user grasps the handle 32 disposed on a front surface of the door 30 to open the door 30. The sensor 40, installed on the handle 32 of the door 30, senses this. Then, electricity is sent to the first and second drive motors 52a and 54a mounted on an upper part of the main body 20, and then the drive motors cause the first and second rotational cams 52b and 54b to rotate.

In the early stage, the first and second rotational cams 52b and 54b rotate at the same time and push the door 30 to separate it from the main body 20 (see FIG. 4A). The first rotational cam 52b finishes its touch with the door 30, but the second rotational cam 54b, having a larger rotational radius than that of the first rotational cam 52b, keeps rotating to make the door 30 open more (see FIG. 4B).

The first and second rotational cams 52b and 54b return to their original positions with a rotational motion after the door 30 finishes opening. At this moment, the switch 60 senses the returning, and cuts off the first and second drive motors 52a and 54a from sources of electricity. Consequently, the first and second rotational cams 52b and 54b return to their original positions and stop automatically.

A door opening method of a refrigerator according to the present invention comprises sensing a user's touch through the sensor 40, disposed on the door 30 of the refrigerator, rotating a plurality of rotational cam units of the rotational cam mechanism 50, each of the rotational cam units having a different rotational radius, according a user's touch to contact them with the door 30 at the same time, opening the door 30 with a larger opening angle of the door 30 through one of the rotational cam units which has a larger rotational radius. Thus, the door 30 can be opened gently from a main body 20 of the refrigerator.

In the door opening method of the refrigerator, the plurality of rotational cam units comprises a first rotational cam unit 52 and a second rotational cam unit 54 for pushing the door to be opened by a rotational movement. The first rotational cam unit 52 is spaced further from a rotational axis of the door 30 than is the second rotational cam unit 54, thereby opening the door 30 stepwise.

Also, the method further comprises having a switch 60 which is contactable with the door 30, and senses a rotation of at least one of the plurality of rotational cam units in the main body 20 of the refrigerator, thereby automatically controlling the door 30 to be opened.

Another embodiment of the present invention relates to a door opening apparatus of a refrigerator. The door opening apparatus of the refrigerator comprises a sensor 40 which is disposed on a door 30 to sense whether or not a user touches the sensor; and a plurality of rotational cam units which are disposed in a main body 20, each of the rotational cam units having a different rotational radius, and open the door 30 stepwise according to a sensing of the sensor 40.

The rotational cam units 50 of the door opening apparatus comprise a first rotational cam unit 52 and a second rotational cam unit 54 for pushing the door 30 to be opened by a rotational movement. The second rotational cam unit 54 has a larger rotational radius than that of the first rotational cam unit 52 to enlarge an opening angle of the door 30. The first and second rotational cam units 52 and 54 of the door opening apparatus comprise first and second drive motors 52a and 54a, and first and second rotational cams 52b and 54b for pushing the door 30 by being respectively rotated due to the first and second drive motors 52a and 54a.

Also, the first and second drive motors 52a and 54a may be controlled to stop after the first and second rotational cams 52b and 54b rotate once. A switch 60, sensing a position of the first and second rotational cams 52b and 54b, enables the first and second drive motors 52a and 54b to stop, thereby automatically controlling the door 30 to be opened. The sensor 40 is disposed on a handle 32 of the door 30 to sense a user's touch and control the door 30 to be opened.

The door opening apparatus of the refrigerator according to the present invention may be employed in various electronic devices which have a door to be gently opened from a main body, as well as a refrigerator.

An operation process of this embodiment of the door opening apparatus of the refrigerator will be omitted as it is the same as that of the foregoing rotational cam mechanisms.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A refrigerator comprising:
a main body having a storage compartment formed therein;
a door formed with a handle on a first side thereof and rotatably disposed on the main body;
a sensor disposed on the door and which senses whether or not a user is touching the sensor; and
a rotational cam mechanism comprising a plurality of rotational cam units, each of the rotational cam units having a different rotational radius, installed in the main body and opening the door sequentially according to a sensing of the sensor.

2. The refrigerator of claim 1, wherein the rotational cam units are rotatable at the same time according to a sensing of the sensor.

3. The refrigerator of claim 1, wherein the plurality of rotational cam units comprises a first rotational cam unit and a second rotational cam unit rotating and pushing the door to be opened, and wherein the second rotational cam unit has a larger rotational radius than that of the first rotational cam unit to open the door with a large angle.

4. The refrigerator of claim 3, wherein the first rotational cam unit is spaced further from a rotational axis of the door than is the second rotational cam unit.

5. The refrigerator of claim 3, wherein the first and second rotational cam units comprise:
first and second drive motors driven according to a sensing of the sensor, respectively; and
first and second rotational cams rotating due to the driving of the first and second drive motors and pushing the door, respectively.

6. The refrigerator of claim 5, wherein the second rotational cam is disposed above the first rotational cam.

7. The refrigerator of claim 5, wherein the first and second drive motors stop after the first and second rotational cams rotate once, respectively.

8. The refrigerator of claim 7, further comprising a switch which is disposed in the main body, and senses a position of at least one of the first and second rotational cams to stop the first and second drive motors.

9. The refrigerator of claim 8, wherein the switch comprises a micro switch operative to contact with the first rotational cam unit.

10. The refrigerator of claim 8, wherein the switch comprises a hall sensor, and the first rotational cam unit is provided with a magnetic member which operates at a predetermined distance from the hall sensor.

11. The refrigerator of claim 1, further comprising a buffer part disposed on an inner surface of the door and which the plurality of rotational cam units contact.

12. A door opening apparatus of a refrigerator which comprises a main body having a storage compartment; and a door rotatably disposed on the main body and having a handle on a first side thereof, the door opening apparatus comprising:
a sensor which is disposed on the door to sense whether or not a user touches the sensor; and
a plurality of rotational cam mechanisms disposed on the main body, each having a different rotational radius, to open the door stepwise according to a sensing of the sensor.

13. The refrigerator of claim 12, wherein the plurality of rotational cam units comprises first and second rotational cam units rotating and pushing the door to be opened, and wherein the second rotational cam unit has a larger rotational radius than that of the first rotational cam unit to open the door with a large angle.

14. The refrigerator of claim 13, wherein the first and second rotational cam units comprise:
first and second drive motors driven according to a sensing of the sensor, respectively; and
first and second rotational cams rotating due to the driving of the first and second drive motors and pushing the door, respectively.

15. The refrigerator of claim 14, wherein the first and second drive motors stop after the first and second rotational cams rotate once, respectively.

16. The refrigerator of claim 15, wherein the first and second drive motors are disposed at positions adjacent to the first and second rotational cams, and are stopped by a switch sensing the position of the first and second rotational cams.

17. The refrigerator of claim 12, wherein the sensor is installed on the handle.

18. A door opening method of a refrigerator, comprising:
sensing a user's touch through a sensor disposed on a door of the refrigerator;
rotating a plurality of rotational cam units, each having a different rotational radius, according to a user's touch to contact them with the door at the same time; and
opening the door with a larger opening angle of the door through one of the rotational cam units, which has a larger rotational radius.

19. The door opening method of claim 18, wherein the plurality of rotational cam units comprises a first rotational cam unit and a second rotational cam unit for pushing the door to be opened by a rotational movement, further comprising separating the first rotational cam unit further from a rotational axis of the door than the second rotational cam unit.

20. The door opening method of claim 18, further comprising contacting a switch with the door to sense a rotation of at least one of the plurality of rotational cam units on the main body of the refrigerator.
